(19) United States
(12) Patent Application Publication
(10) Pub. No.: US 2025/0340122 A1
(43) Pub. Date: Nov. 6, 2025

(54) BATTERY PACK PRE-CHARGING

(71) Applicant: Caterpillar Inc., Peoria, IL (US)

(72) Inventors: Avinash DONGARE, Bangalore (IN); Murali Krishnan RAGHUPATHY, Bangalore (IN)

(73) Assignee: Caterpillar Inc., Peoria, IL (US)

(21) Appl. No.: 18/656,464

(22) Filed: May 6, 2024

(51) Int. Cl. B60L 3/00

(52) U.S. Cl. CPC B60L 3/0046; B60L 2240/427; B60L 2250/10

(57) ABSTRACT

A pre-charging controller may compare a pre-charging voltage of a machine component to a first voltage threshold. The pre-charging controller may compare a pre-charging current of the machine component to a first current threshold. The pre-charging controller may set a second voltage threshold and a second current threshold as a result of the pre-charging voltage being below the first voltage threshold and the pre-charging current being above the first current threshold.

### TECHNICAL FIELD

The present disclosure relates generally to pre-charging a load connected to a battery pack and, for example, to adjusting one or more pre-charging thresholds to prevent a pre-charging operation failure.

### BACKGROUND

A battery pre-charging process involves increasing a load-side voltage (e.g., a voltage at a load) to a voltage close to that of a voltage of a battery before connecting the battery to the load. Pre-charging helps to raise the load-side voltage to a level where the load can accept the full output of the battery while minimizing the risk of damage to the load. If the pre-charging process fails, a battery controller may disconnect the load from the battery until the battery and/or load can be serviced. In the context of electrically-powered machinery, a disruption in the pre-charging process may cause the machinery to become stranded, resulting in a negative user experience, delayed projects, and the like.

U.S. Pat. No. 11,342,772 (the '772 patent) discloses a precharge controller which closes a precharge contactor and precharges a capacitor before closing a main contactor, capable of preventing a false determination of completion of precharge even when a current sensor fails. The precharge controller of the '722 patent does not permit additional pre-charging attempts after detecting a failure. Therefore, once the precharge operation has failed, the vehicle occupant may be stranded until the vehicle can be serviced.

The pre-charging controller of the present disclosure solves one or more of the problems set forth above and/or other problems in the art.

### SUMMARY

A machine may include an electric motor; a battery pack, having one or more batteries, electrically connected to the electric motor and configured to power the electric motor; and a pre-charging controller configured to: determine, as part of an initial pre-charging operation, a pre-charging voltage of the one or more batteries in the battery pack; compare the pre-charging voltage to a first voltage threshold; and set a second voltage threshold for a subsequent pre-charging operation as a result of the pre-charging voltage being below the first voltage threshold.

A method may include comparing a pre-charging voltage of one or more batteries in a battery pack to a first voltage threshold; comparing a pre-charging current of the one or more batteries in the battery pack to a first current threshold; and setting a second voltage threshold and a second current threshold as a result of the pre-charging voltage being below the first voltage threshold and the pre-charging current being above the first current threshold.

A pre-charging controller may include one or more memories; one or more processors, communicatively coupled to the one or more memories, configured to: compare a pre-charging voltage of one or more batteries in a battery pack to a first voltage threshold; compare a pre-charging current of the one or more batteries in the battery pack to a first current threshold; and set a second voltage threshold and a second current threshold as a result of the pre-charging voltage being below the first voltage threshold and the pre-charging current being above the first current threshold.

### BRIEF DESCRIPTION OF THE DRAWINGS

FIG. 1 is a diagram of an example battery pack.

FIG. 2 illustrates an example voltage graph and an example current graph showing voltage and current, respectively, during a pre-charging operation of a load connected to one or more battery packs of a machine.

FIG. 3 is a diagram of an example implementation associated with pre-charging the load connected to the one or more battery packs of a machine.

FIG. 4 is a flowchart of an example process associated with battery pack pre-charging.

### DETAILED DESCRIPTION

This disclosure relates to pre-charging a load (e.g., an electric motor) connected to a battery pack, which is applicable to any machine that includes one or more batteries. For example, the machine may be an electric vehicle, an electric work machine (e.g., a compactor machine, a paving machine, a cold planer, a grading machine, a backhoe loader, a wheel loader, a harvester, an excavator, a motor grader, a skid steer loader, a tractor, and/or a dozer), or an energy storage system, among other examples. As used herein, the terms “battery cell,” “battery,” and “cell” may be interchangeable.

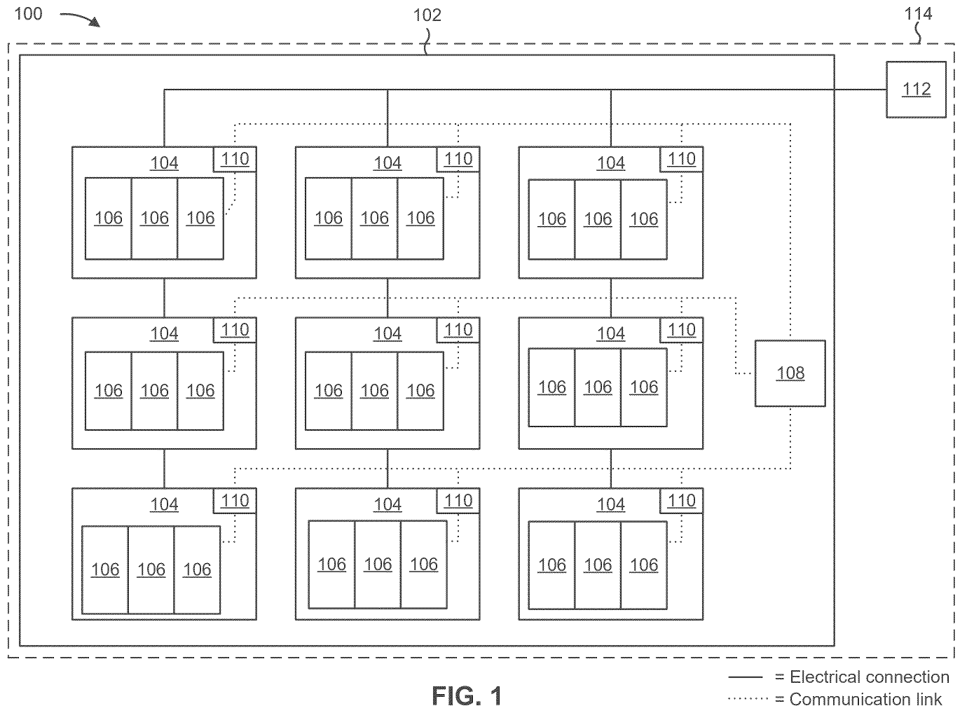

FIG. 1 is a diagram of an example battery pack 100. The battery pack 100 may include a battery pack housing 102, one or more battery modules 104, and one or more battery cells 106. The battery pack 100 includes a battery pack controller 108 associated with storing information and/or controlling one or more operations associated with the battery pack 100. Each battery module 104 includes a module controller 110 associated with storing information and/or controlling one or more operations associated with the battery module 104.

The battery pack 100 may be associated with a component 112. The component 112 may be powered by the battery pack 100. For example, the component 112 can be a load that consumes energy provided by the battery pack 100, such as an electric motor, among other examples. As another example, the component 112 provides energy to the battery pack 100 (e.g., to be stored by the battery cells 106). In such examples, the component 112 may be a power generator, a solar energy system, and/or a wind energy system, among other examples. A machine 114 may include the battery pack 100 and the component 112 (e.g., an electric motor). For example, the battery pack 100 (e.g., one or more battery modules 104 thereof) may be electrically connected to the component 112. The machine 114 may be an electric vehicle (e.g., a car, a train, or a boat) or an electric work machine.

The battery pack housing 102 may include metal shielding (e.g., steel, aluminum, or the like) to protect elements (e.g., battery modules 104, battery cells 106, the battery pack controller 108, the module controllers 110, wires, circuit boards, or the like) positioned within battery pack housing 102. Each battery module 104 includes one or more (e.g., a plurality of) battery cells 106 (e.g., positioned within a housing of the battery module 104). Battery cells 106 may be connected in series and/or in parallel within the battery module 104 (e.g., via terminal-to-busbar welds). Each battery cell 106 is associated with a chemistry type. The chemistry type may include lithium ion (Li-ion), nickel-metal hydride (NiMH), nickel cadmium (NiCd), lithium ion polymer (Li-ion polymer), lithium iron phosphate (LFP), and/or nickel manganese cobalt (NMC), among other examples.

The battery modules 104 may be arranged within the battery pack 100 in one or more strings. For example, the battery modules 104 are connected via electrical connections, as shown in FIG. 1. The electrical connections may be removable, such as via bolts and/or nuts at one or more terminals on housings of the battery modules 104. The battery modules 104 may be connected in series and/or in parallel. For example, a number of battery modules 104 may be connected in series to provide a particular voltage (e.g., to the component 112). Alternatively, a number of battery modules 104 may be connected in parallel to increase a current and/or a power output of the battery pack 100. The number of battery cells 106 included in each battery module 104, and the number of battery modules 104 included in the battery pack 100 (e.g., and the relative serial and/or parallel connections of the battery cells 106 and/or the battery modules 104) may be associated with the required output power and an intended use of the battery pack 100. For example, any number of battery cells 106 can be included in a battery module 104. Similarly, any number of battery modules 104 can be included in the battery pack 100.

The battery pack controller 108 is communicatively connected (e.g., via a communication link) to each module controller 110. The battery pack controller 108 may be associated with receiving, generating, storing, processing, providing, and/or routing information associated with the battery pack 100. The battery pack controller 108 may also be referred to as a battery pack management device or system. The battery pack controller 108 may communicate with the component 112 and/or a controller of the component 112, may control a start-up and/or shut-down procedure of the battery pack 100, may monitor a current and/or voltage of a string (e.g., of battery modules 104), and/or may monitor and/or control a current and/or voltage provided by the battery pack 100, among other examples. A module controller 110 may be associated with receiving, generating, storing, processing, providing, and/or routing information associated with a battery module 104. The module controller 110 may communicate with the battery pack controller 108.

The battery pack controller 108 and/or a module controller 110 may be associated with monitoring and/or determining a state of charge (SOC), a state of health (SOH), a depth of discharge (DOD), an output voltage, a temperature, and/or an internal resistance and impedance, among other examples, associated with a battery module 104 and/or associated with the battery pack 100. Additionally, or alternatively, the battery pack controller 108 and/or the module controller 110 may be associated with monitoring, controlling, and/or reporting one or more parameters associated with battery cells 106. The one or more parameters may include cell voltages, temperatures, chemistry types, a cell energy throughput, a cell internal resistance, and/or a quantity of charge-discharge cycles of a battery module 104, among other examples.

As indicated above, FIG. 1 is provided as an example. Other examples may differ from what is described with regard to FIG. 1.

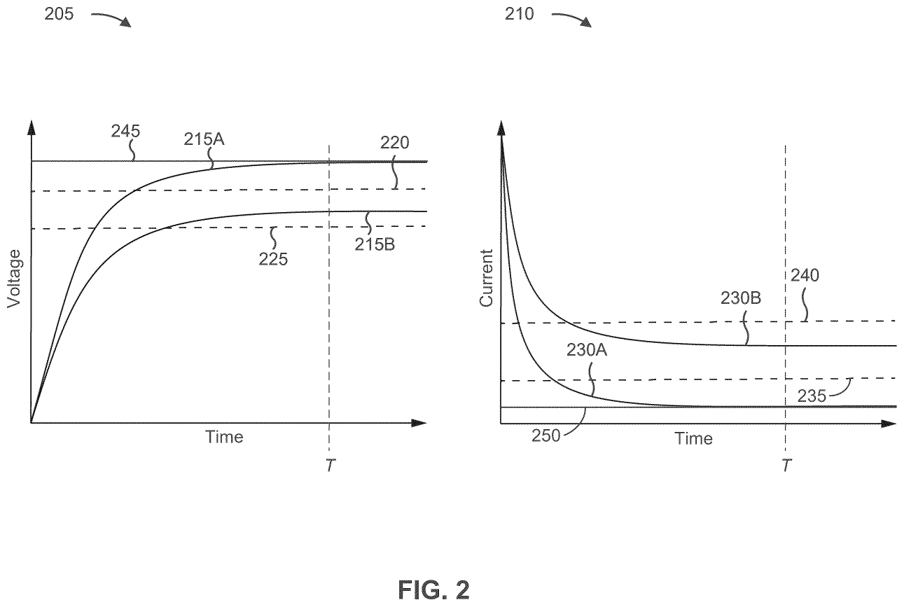

FIG. 2 illustrates an example voltage graph 205 and an example current graph 210 showing voltage and current, respectively, during a pre-charging operation of a load (e.g., an electric motor or another electrically powered device of the machine) electrically connected to one or more battery packs. As shown in FIG. 2, the voltage output to the load and the current output to the load may change during the pre-charging operation. As discussed in greater detail below, the pre-charging operation may include an initial pre-charging operation (e.g., a first pre-charging operation) and/or a subsequent pre-charging operation (e.g., a second pre-charging operation).

The voltage graph 205 shows voltage on a vertical axis and time on a horizontal axis. During a successful pre-charging operation, a load-side voltage 215 (e.g., the voltage provided to the load) may quickly increase before reaching a load-side voltage at or near a battery-side voltage 245 (e.g., a voltage output by the battery). The initial pre-charging operation may be deemed successful if the load-side voltage 215 exceeds a first voltage threshold 220 by a steady-state time T. The first voltage threshold 220 may be based on, for example, the battery-side voltage 245. An example of the load-side voltage 215 exceeding the first voltage threshold 220 is shown by reference number 215A in FIG. 2. The initial pre-charging operation may fail if the load-side voltage 215 does not reach the first voltage threshold 220 by the steady-state time T. An example of the load-side voltage 215 not reaching the first voltage threshold 220 is shown by reference number 215B in FIG. 2. As discussed in greater detail below, a second voltage threshold 225 may be applied in certain circumstances, such as during a subsequent pre-charging operation after the initial pre-charging operation is deemed to have failed. During the subsequent pre-charging operation, if the load-side voltage 215 exceeds the second voltage threshold 225 by the steady-state time T (as shown by load-side voltage level 215B in FIG. 2), the subsequent pre-charging operation may be deemed successful. Otherwise, during the subsequent pre-charging operation, if the load-side voltage 215 is below the second voltage threshold 225 at the steady-state time T, the subsequent pre-charging operation may be deemed to have failed.

The second voltage threshold 225 may be set at a lower voltage level than the first voltage threshold 220 to increase the likelihood that the load-side voltage 215 will exceed the second voltage threshold 225 despite not exceeding the first voltage threshold 220. The voltage level of the second voltage threshold 225 may account for circumstances where the pre-charging operation would be successful but for an event that interfered with the pre-charging operation. For example, the second voltage threshold 225 may be set to account for an event, such as a battery-powered component of a machine (e.g., an electric vehicle or an electric work machine) activating before or during the initial pre-charging operation, that reduced the load-side voltage 215.

The current graph 210 shows current on a vertical axis and time on a horizontal axis. During a successful pre-charging operation, the load-side current 230 (e.g., the current provided to the load) may quickly decrease before reaching a load-side current. The initial pre-charging operation may be deemed successful if the load-side current 230 drops below a first current threshold 235 by a steady-state time T, as shown by load-side current 230A in FIG. 2. The initial pre-charging operation may fail if the load-side current 230 does not drop below the first current threshold 235 by the steady-state time T, as shown by load-side current 230B in FIG. 2. The first current threshold 235 may be based on a battery-side current 250 (e.g., a current output by the battery). As discussed in greater detail below, a second current threshold 240 may be set and applied in certain circumstances, such as during a subsequent pre-charging operation after an initial pre-charging operation is deemed to have failed. During the subsequent pre-charging operation, if the load-side current 230 is below the second current threshold 240 by the steady-state time T, the subsequent pre-charging operation may be deemed successful (as shown by load-side current 230A in FIG. 2). Otherwise, during the subsequent pre-charging operation, if the load-side current 230 is above the second current threshold 240 at the steady-state time T, the subsequent pre-charging operation may be deemed to have failed.

The second current threshold 240 may be set at a higher current level than the first current threshold 235 to increase the likelihood that the load-side current 230 will fall below the second current threshold 240 despite being above the first current threshold 235. The current level of the second current threshold 240 may account for circumstances where the pre-charging operation would be successful but for an event that interferes with the pre-charging operation (e.g., an event that keeps the load-side current 230 above the first current threshold 235.

As discussed in greater detail below, the success or failure of the pre-charging operation (e.g., the initial pre-charging operation and/or the subsequent pre-charging operation) may be based on the load-side voltage 215 relative to the first voltage threshold 220 and/or the second voltage threshold 225, the load-side current 230 relative to the first current threshold 235 and/or the second current threshold 240, and/or a combination thereof, among other examples.

As indicated above, FIG. 2 is provided as an example. Other examples may differ from what is described with regard to FIG. 2.

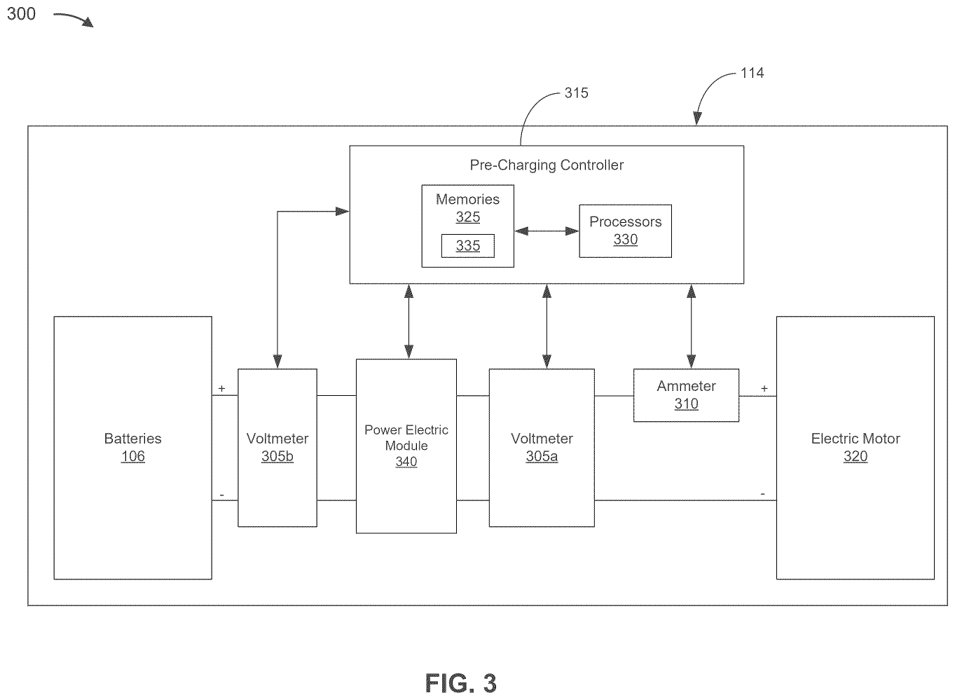

FIG. 3 is a diagram of an example implementation 300 associated with pre-charging a load (e.g., component 112 of FIG. 1) of a machine (e.g., machine 114) connected to one or more battery cells 106 in a battery pack. As shown in FIG. 3, example implementation 300 includes voltmeters 305, an ammeter 310, and a pre-charging controller 315, and the battery pack is used to power the component, shown as an electric motor 320, of the machine.

The voltmeters 305 may be electrically connected to the electric motor 320 (voltmeter 305a) and to the batteries 106 (voltmeter 305b) for measuring the load-side voltage (e.g., the load-side voltage 215) during a pre-charging operation, including an initial pre-charging operation and a subsequent pre-charging operation. The load-side voltage measured by the voltmeter 305a during the pre-charging operation may be referred to as the pre-charging voltage. The voltmeter 305a may be configured to output a voltage signal indicating the pre-charging voltage. For example, during the initial pre-charging operation, the voltmeter 305a may be configured to output a first voltage signal at the steady-state time T or during a first steady-state voltage time period (e.g., a time period, during an initial pre-charging operation, that includes the steady-state time T of FIG. 2). Further, during the second pre-charging operation, the voltmeter 305a may be configured to output a second voltage signal at the steady-state time T or during a second steady-state voltage time period (e.g., a time period, during a subsequent pre-charging operation, that includes the steady-state time T of FIG. 2). The first steady-state voltage time period and the second steady-state voltage time period may be the same or different lengths of time.

The ammeter 310 may be electrically connected to the electric motor 320 and to the batteries 106 and configured to measure a load-side current during a pre-charging operation, including the initial pre-charging operation and/or the subsequent pre-charging operation. The current measured by the ammeter 310 during the pre-charging operation may be referred to as the pre-charging current. The ammeter 310 may be configured to output a current signal indicating the pre-charging current. For example, during the initial pre-charging operation, the ammeter 310 may be configured to output a first current signal at the steady-state time T or during a first steady-state current time period (e.g., a time period, during the initial pre-charging operation, including the steady-state time T of FIG. 2). Further, during the subsequent pre-charging operation, the ammeter 310 may be configured to output a second current signal at the steady-state time T or during a second steady-state current time period (e.g., a time period, during the subsequent pre-charging operation, including the steady-state time T of FIG. 2). The first steady-state current time period and the second steady-state current time period may be the same or different lengths of time.

The pre-charging controller 315 may include any number of chips, circuits, memories 325, processors 330, and/or any other electronic components configured to facilitate the pre-charging operation. The pre-charging controller 315 may be configured to receive the voltage signal output by the voltmeter 305a to determine the pre-charging voltage. The pre-charging controller 315 may be configured to receive the current signal output by the ammeter 310 to determine the pre-charging current. The pre-charging controller 315 may be incorporated into the battery pack controller 108. Alternatively, the pre-charging controller 315 may be separate from the battery pack controller 108.

During the initial pre-charging operation, the pre-charging controller 315 may be configured to output a control signal to a power electric module 340, which may include main contactors, a pre-charge circuit, one or more switches, relays, or other components that can be used to control an amount of voltage and/or current provided to the electric motor 320 during the initial pre-charging operation. Further, during the initial pre-charging operation, the pre-charging controller 315 may be configured to receive, from the voltmeter 305a, the pre-charging voltage via the voltage signal. The pre-charging controller 315 may be further configured to set the first voltage threshold and compare the pre-charging voltage to the first voltage threshold, which as discussed above may indicate the load-side voltage at the steady-state time T or during the first steady-state time period, to determine whether the pre-charging voltage exceeds the first voltage threshold. If the pre-charging controller 315 determines that the pre-charging voltage exceeds the first voltage threshold, the pre-charging controller 315 may be configured to end the pre-charging operation, which may include outputting a control signal to the power electric module 340 that allows a full battery operation to begin (e.g., allows the electric motor 320 to be fully powered by the batteries 106). If the pre-charging controller 315 determines that the load-side voltage does not exceed the first voltage threshold, the pre-charging controller 315 may end the initial pre-charging operation and begin a subsequent pre-charging operation.

During the subsequent pre-charging operation, the pre-charging controller 315 may be configured to output a control signal to the power electric module 340 to control the load-side voltage and/or the load-side current, set the second voltage threshold, and compare the pre-charging voltage to the second voltage threshold. The pre-charging controller 315 may be configured to receive an updated voltage signal, indicating the pre-charging voltage during the subsequent pre-charging operation (e.g., at the steady-state time T or during the second steady-state voltage time period), from the voltmeter 305a. Alternatively, the pre-charging controller 315 may be configured to use, during the subsequent pre-charging operation, the same pre-charging voltage measured during the initial pre-charging operation. The pre-charging controller 315 may be configured to compare the pre-charging voltage to the second voltage threshold. If the pre-charging voltage exceeds the second voltage threshold during the subsequent pre-charging operation, the pre-charging controller 315 may be configured to end the subsequent pre-charging operation and output a control signal to the power electric module 340 to allow a full battery operation to begin. If, during the subsequent pre-charging operation, the pre-charging controller 315 determines that the load-side voltage pre-charging voltage does not exceed the second voltage threshold, the pre-charging controller 315 may output an alert signal, indicating, to a user of the machine, that the pre-charging operation has failed. Even if the load-side voltage exceeds the second voltage threshold during the subsequent pre-charging operation, the pre-charging controller may be configured to output, after a failed initial pre-charging operation, the alert signal indicating, to the user of the machine, that service of the machine is required and that the machine may be inoperable once turned off. The alert signal may include an audible or visual alert. The alert signal may indicate, to the user, that the machine must be serviced as soon as possible. The alert signal may indicate, to the user, that the machine may not be powered on once the machine is powered off. Additionally or alternatively, the pre-charging controller 315 may be configured to output a diagnostic trouble code (DTC) indicator (e.g., set a DTC flag) as a result of the pre-charging voltage being below the second voltage threshold. The DTC may indicate, to the user, that the machine should be serviced as soon as possible. The DTC may further or alternatively indicate, to the user or to a technician, why the initial pre-charging operation and/or the subsequent pre-charging operation failed.

During the initial pre-charging operation, the pre-charging controller 315 may be further or alternatively configured to receive, from the ammeter 310, the pre-charging current via the current signal. The pre-charging controller 315 may be further configured to set the first current threshold and compare the pre-charging current to the first current threshold, which as discussed above may indicate the load-side current at the steady-state time T or during the first steady-state time period, to determine whether the pre-charging current is below the first current threshold. If the pre-charging controller 315 determines that the pre-charging current is below the first current threshold, the pre-charging controller 315 may be configured to end the pre-charging operation, which may include outputting a control signal to the power electric module 340 that allows a full battery operation to begin. If the pre-charging controller 315 determines that the pre-charging current is greater than the first current threshold, the pre-charging controller 315 may begin a subsequent pre-charging operation.

During the subsequent pre-charging operation, the pre-charging controller 315 may be configured to set the second current threshold and compare the pre-charging current to the second current threshold. The pre-charging controller 315 may be configured to receive an updated current signal, indicating the pre-charging current during the subsequent pre-charging operation (e.g., during the second steady-state current time period), from the ammeter 310. Alternatively, the pre-charging controller 315 may be configured to use, during the subsequent pre-charging operation, the same pre-charging current measured during the initial pre-charging operation. The pre-charging controller 315 may be configured to compare the pre-charging current to the second current threshold. If the pre-charging current exceeds the second current threshold during the subsequent pre-charging operation, the pre-charging controller 315 may be configured to end the pre-charging operation, which, as discussed above, may include outputting a control signal to the power electric module 340 that allows a full battery operation to begin. If the pre-charging controller 315 determines that the pre-charging current does not exceed the second current threshold, the pre-charging controller 315 may output an alert signal, indicating, to a user of the machine, that the pre-charging operation has failed. Even if the load-side current is below the second current threshold during the subsequent pre-charging operation, as discussed above, the pre-charging controller may be configured to output, after a failed initial pre-charging operation, the alert signal indicating, to the user of the machine, that service of the machine is required and that the machine may be inoperable once turned off.

The pre-charging controller 315 may include one or more memories 325, one or more processors 330, and/or a combination thereof, among other examples. The one or more memories 325 may be electronic data storage devices that are individually or collectively configured to store instructions executable by the one or more processors 330. Additionally, the one or more memories 325 may be individually or collectively configured to store information associated with the pre-charging operation. For example, the one or more memories 325 may store the first voltage threshold, the second voltage threshold, the first current threshold, the second current threshold, the pre-charging voltage, the pre-charging current, and/or a combination thereof, among other examples. The one or more memories 325 may be configured to store the information associated with the battery pre-charging operation in one or more lookup tables 335.

The one or more processors 330 may include chips, circuits, or other electronic devices that are individually or collectively configured to perform the pre-charging operation, including the initial pre-charging operation and/or the subsequent pre-charging operation. For example, the one or more processors 330 may be configured to access and execute the instructions stored in the one or more memories 325 to perform the initial pre-charging operation, perform the subsequent pre-charging operation, receive the voltage signal, receive the current signal, compare the pre-charging voltage to the first voltage threshold and/or the second voltage threshold, compare the pre-charging current to the first charging threshold and/or the second charging threshold, output the alert signal, and/or a combination thereof, among other examples. Further, the one or more processors 330 may be configured to access information, stored in the one or more memories 325, associated with the pre-charging operation. For example, the one or more processors 330 may be configured to access, from the memory, the first voltage threshold, the second voltage threshold, the first current threshold, the second current threshold, and/or a combination thereof, among other examples. Values for the first voltage threshold, the second voltage threshold, the first current threshold, and/or the second current threshold may be based on various factors such as an expected pre-charging value (e.g., an expected voltage during a successful pre-charging operation or an expected current during a successful pre-charging operation), an accuracy of a sensor (e.g., an accuracy of the voltmeter 305a and/or an accuracy of the ammeter 310), an error tolerance of a sensor (e.g., an error tolerance of the voltmeter 305a and/or an error tolerance of the ammeter 310), and/or a combination thereof, among other examples. As discussed above, the first voltage threshold, the second voltage threshold, the first current threshold, and/or the second current threshold may be stored in a lookup table 335. The one or more processors 330, to set the first voltage threshold, the second voltage threshold, the first current threshold, and/or the second current threshold, may be configured to query the lookup table 335 to determine one or more of the first voltage threshold, the second voltage threshold, the first current threshold, or the second current threshold.

Accordingly, the pre-charging controller 315 may be configured to determine, as part of an initial pre-charging operation, the load-side voltage of a component (e.g., the electric motor 320) connected to one or more batteries 106 in the battery pack; compare the pre-charging voltage to the first voltage threshold; and set a second voltage threshold for a subsequent pre-charging operation as a result of the pre-charging voltage being below the first voltage threshold. The pre-charging controller 315 may be further configured to determine, as part of the initial pre-charging operation, a pre-charging current of the component; compare the pre-charging current to a pre-first current threshold; and set a second current threshold for the subsequent pre-charging operation as a result of the pre-charging current being above the first current threshold and the pre-charging voltage being below the first voltage threshold. With a successful subsequent pre-charging operation following a failed initial pre-charging operation, the pre-charging controller 315 may allow pre-charging to continue, which can provide sufficient functionality for the user of the machine to have the machine serviced.

As indicated above, FIG. 3 is provided as an example. Other examples may differ from what is described with regard to FIG. 3.

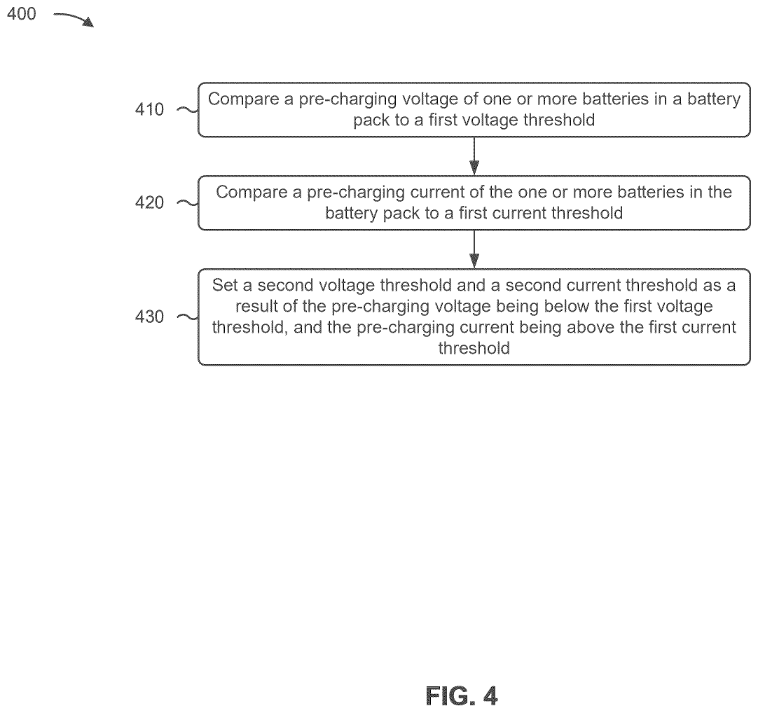

FIG. 4 is a flowchart of an example process 400 associated with battery pack pre-charging. One or more process blocks of FIG. 4 may be performed by a pre-charging controller 315. Additionally, or alternatively, one or more process blocks of FIG. 4 may be performed by another device or a group of devices separate from or including the pre-charging controller 315, such as another device or component that is internal or external to the machine and/or the battery pack 100.

As shown in FIG. 4, process 400 may include comparing a pre-charging voltage of a component electrically connected to one or more batteries in a battery pack to a first voltage threshold (block 410). For example, the pre-charging controller 315 may compare a pre-charging voltage of the component electrically connected to the one or more batteries in a battery pack to a first voltage threshold, as described above.

As further shown in FIG. 4, process 400 may include comparing a pre-charging current of the component electrically connected to the one or more batteries in the battery pack to a first current threshold (block 420). For example, the pre-charging controller 315 may compare a pre-charging current of the component electrically connected to the one or more batteries in the battery pack to a first current threshold, as described above.

As further shown in FIG. 4, process 400 may include setting a second voltage threshold and a second current threshold as a result of the pre-charging voltage being below the first voltage threshold and the pre-charging current being above the first current threshold (block 430). For example, the pre-charging controller 315 may set a second voltage threshold and a second current threshold as a result of the pre-charging voltage being below the first voltage threshold and the pre-charging current being above the first current threshold, as described above. Setting the second voltage threshold may include setting the second voltage threshold to a value below the first voltage threshold, and setting the second current threshold may include setting the second current threshold to a value above the first current threshold. The first voltage threshold and/or the second voltage threshold may be based, at least in part, on one or more of an expected pre-charging voltage, an accuracy of a voltmeter 305a, or an error tolerance of the voltmeter 305a. The first current threshold and/or the second current threshold may be based, at least in part, on one or more of an expected pre-charging current, an accuracy of an ammeter 310, or error tolerance of the ammeter 310.

Process 400 may include determining the pre-charging voltage of the component electrically connected to the one or more batteries in the battery pack. Process 400 may include determining the pre-charging current of the component electrically connected to the one or more batteries in the battery pack.

Process 400 may include outputting a DTC indicator as a result of the pre-charging voltage being below the first voltage threshold and/or the pre-charging current being above the first current threshold.

Process 400 may include outputting an alert signal as a result of the pre-charging voltage being below the first voltage threshold and/or the pre-charging current being above the first current threshold.

Process 400 may include performing a first pre-charging operation using the first voltage threshold and/or the first current threshold. Process 400 may include performing a second pre-charging operation using the second voltage threshold and/or the second current threshold. The second pre-charging operation may occur as a result of the pre-charging voltage being below the first voltage threshold and/or the pre-charging current being above the first current threshold.

Process 400 may include querying a lookup table to determine one or more of the first voltage threshold, the second voltage threshold, the first current threshold, or the second current threshold.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

### INDUSTRIAL APPLICABILITY

The pre-charging controller discussed above can be used to perform a pre-charging operation on a component (such as an electric motor) electrically connected to one or more batteries of a machine (such as an electric vehicle, an electric work machine (e.g., a compactor machine, a paving machine, a cold planer, a grading machine, a backhoe loader, a wheel loader, a harvester, an excavator, a motor grader, a skid steer loader, a tractor, and/or a dozer), or an energy storage system, among other examples).

If a pre-charging operation of the component fails, the machine may need to be serviced. The nature of the failure, however, may allow the machine to be used one more time, which may allow the user to have the machine serviced. Accordingly, in response to a failed initial pre-charging operation, allowing a subsequent pre-charging operation with a modified voltage threshold and/or modified current threshold may allow pre-charging to continue to give the user an opportunity to operate the machine in at least a limited capacity (e.g., a “limp-home” mode) so the user can have the machine serviced.

What is claimed is:

1. A machine, comprising:
an electric motor;
a battery pack, having one or more batteries, electrically connected to the electric motor and configured to power the electric motor; and
a pre-charging controller configured to:
determine, as part of an initial pre-charging operation, a pre-charging voltage of the electric motor;
compare the pre-charging voltage to a first voltage threshold; and
set a second voltage threshold for a subsequent pre-charging operation as a result of the pre-charging voltage being below the first voltage threshold.

2. The machine of claim 1, wherein the pre-charging controller is further configured to set the second voltage threshold to a value below the first voltage threshold.

3. The machine of claim 1, wherein the pre-charging controller is further configured to output a diagnostic trouble code indicator as a result of the pre-charging voltage being below the first voltage threshold.

4. The machine of claim 1, wherein the pre-charging controller is further configured to output an alert signal as a result of the pre-charging voltage being below the first voltage threshold.

5. The machine of claim 1, wherein the pre-charging controller is further configured to perform the subsequent pre-charging operation using the second voltage threshold as a result of the pre-charging voltage being below the first voltage threshold.

6. The machine of claim 1, wherein the pre-charging controller is further configured to query a lookup table for one or more of the first voltage threshold or the second voltage threshold.

7. The machine of claim 1, wherein the pre-charging controller is further configured to:
determine, as part of the initial pre-charging operation, a pre-charging current of the electric motor;
compare the pre-charging current of the electric motor to a pre-first current threshold; and
set a second current threshold for the subsequent pre-charging operation as a result of the pre-charging current being above the first current threshold and the pre-charging voltage being below the first voltage threshold.

8. The machine of claim 7, wherein the pre-charging controller is further configured to set the second current threshold to a value above the first current threshold.

9. The machine of claim 7, wherein the pre-charging controller is configured to query a lookup table for one or more of the first current threshold or the second current threshold.

10. A method, comprising:
comparing a pre-charging voltage of a machine component to a first voltage threshold;
comparing a pre-charging current of the machine component to a first current threshold; and
setting a second voltage threshold and a second current threshold as a result of:
the pre-charging voltage being below the first voltage threshold, and
the pre-charging current being above the first current threshold.

11. The method of claim 10, wherein setting the second voltage threshold includes setting the second voltage threshold to a value below the first voltage threshold, and
wherein setting the second current threshold includes setting the second current threshold to a value above the first current threshold.

12. The method of claim 10, further comprising determining the pre-charging voltage of the machine component.

13. The method of claim 10, further comprising determining the pre-charging current of the machine component.

14. The method of claim 10, wherein one or more of the first voltage threshold or the second voltage threshold are based, at least in part, on one or more of an expected pre-charging voltage, an accuracy of a voltmeter, or an error tolerance of the voltmeter.

15. The method of claim 10, wherein one or more of the first current threshold or the second current threshold are based, at least in part, on one or more of an expected pre-charging current, an accuracy of an ammeter, or error tolerance of the ammeter.

16. The method of claim 10, further comprising outputting a diagnostic trouble code indicator as a result of the pre-charging voltage being below the first voltage threshold and the pre-charging current being above the first current threshold.

17. The method of claim 10, further comprising outputting an alert signal as a result of the pre-charging voltage being below the first voltage threshold and the pre-charging current being above the first current threshold.

18. The method of claim 10, further comprising:
performing a first pre-charging operation using the first voltage threshold and the first current threshold; and
performing a second pre-charging operation using the second voltage threshold and the second current threshold as a result of the pre-charging voltage being below the first voltage threshold and the pre-charging current being above the first current threshold.

19. The method of claim 10, further comprising querying a lookup table to determine one or more of the first voltage threshold, the first current threshold, the second voltage threshold, or the second current threshold.

20. A pre-charging controller, comprising:
one or more memories;
one or more processors, communicatively coupled to the one or more memories, configured to:
compare a pre-charging voltage of a machine component to a first voltage threshold;
compare a pre-charging current of the machine component to a first current threshold; and
set a second voltage threshold and a second current threshold as a result of the pre-charging voltage being below the first voltage threshold, and the pre-charging current being above the first current threshold.
